(19) United States
(12) Patent Application Publication
(10) Pub. No.: US 2022/0398893 A1
(43) Pub. Date: Dec. 15, 2022

(54) Methods, Apparatuses, Devices And Storage Media For Controlling Game States

(71) Applicant: SENSETIME INTERNATIONAL PTE. LTD., Singapore (SG)

(72) Inventors: Xinxin Wang, Singapore (SG); Fei Xie, Singapore (SG); Shuai Zhang, Singapore (SG)

(21) Appl. No.: 17/364,520

(22) Filed: Jun. 30, 2021

Related U.S. Application Data
(63) Continuation of application No. PCT/IB2021/055740, filed on Jun. 28, 2021.

(30) Foreign Application Priority Data
Jun. 14, 2021 (SG) 10202106354X

(51) Int. Cl. G07F 17/32; G06K 9/00; G06T 7/70

(52) U.S. Cl. CPC G07F 17/326; G06K 9/00744; G06T 7/70; G07F 17/3293; G06K 2209/21; G06T 2207/10016

(57) ABSTRACT

The present disclosure provides a method, an apparatus, a device and a storage medium for controlling game states. The method includes: in response to that a game is in a preset prop operating state, obtaining a video stream of a game region, wherein the game region comprises a placement region for placing one or more game items; determining whether a game item is present in the placement region by performing detection on the video stream; in response to that the game item is present in the placement region, determining a state of the game item based on the video stream; and in response to that the game item is in a preset stable state, switching the game to an item operating state.

### CROSS-REFERENCE TO RELATED APPLICATION

The present application is a continuation of International Application No. PCT/IB2021/055740 filed on Jun. 28, 2021, which claims priority to Singapore Patent Application No. 10202106354X, filed on Jun. 14, 2021, all of which are incorporated herein by reference in their entirety.

### TECHNICAL FIELD

The present disclosure relates to the field of computer vision technologies, and in particular to a method, an apparatus, a device and a storage medium for controlling game states.

### BACKGROUND

A complete game is usually divided into a plurality of different states. In the process of a game, the game is switched to a corresponding state based on a game progress, so that whether a process of the game indicates abnormal can be supervised based on a corresponding rule in different states, for example, whether a game player follows a game rule is supervised. In a smart game analysis scenario, timely switching of game states has great significance for the real-timeness of a game analysis result and the reliability of performing operations such as warning based on the real-time game analysis result.

### SUMMARY

The present disclosure provides a method, an apparatus, a device and a storage medium for controlling game states to solve the defects in the related art.

According to a first aspect of an embodiment of the present disclosure, provided is a method of controlling game states, including: obtaining, in response to that a game is in a preset prop operating state, a video stream of a game region, wherein the game region includes a placement region for placing one or more game items; determining whether a game item is present in the placement region by performing detection on the video stream; determining, in response to that the game item is present in the placement region, a state of the game item based on the video stream; and in response to that the game item is in a preset stable state, switching the game to an item operating state.

In some embodiments, determining whether the game item is present in the placement region by performing the detection on the video stream includes: obtaining a confidence of the game item in the placement region by performing game item detection for at least one image in the video stream; and determining, in response to that the confidence of the game item in the placement region is greater than a preset confidence threshold, the game item is present in the placement region.

In some embodiments, determining the state of the game item based on the video stream includes: obtaining a detection result obtained by performing game item detection for a plurality of successive images in the video stream, where the detection result includes a position of the game item in each of the plurality of successive images; determining, in response to that the plurality of successive images include at least one first target image, the game item is in the preset stable state; where a first position corresponding to the game item in the first target image is within the placement region, and a distance between the first position with respect to each of second positions is smaller than a first preset distance threshold or a distance between the first position with respect to each of third positions is smaller than the first preset distance threshold, the second positions indicate respective positions corresponding to the game item in n previous frames of the first target image, the third positions indicate respective positions corresponding to the game item in n subsequent frames of the first target image, and n is a positive integer.

In some embodiments, the placement region includes at least two placement sub-regions; determining whether the game item is present in the placement region by performing the detection on the video stream includes: determining, for each of the placement sub-regions of the placement region, whether the game item is present in the placement sub-region by performing the detection on the placement sub-region based on the video stream; and determining, in response to that the game item is present in any one of the placement sub-regions, the game item is present in the placement region.

In some embodiments, determining the state of the game item based on the video stream includes: detecting an operating object for the game item based on the video stream; and determining the state of the game item based on a detection result of the operating object.

In some embodiments, detecting the operating object for the game item based on the video stream includes: detecting a second target image in which a game item is present in the placement region from the video stream; and detecting the operating object for the game item from a previous frame of the second target image.

In some embodiments, detecting the operating object for the game item from the previous frame of the second target image includes: detecting an operating object in the placement region from the previous frame of the second target image; and determining, in response to detecting the operating object being present in the placement region from the previous frame of the second target image, that the operating object for the game item is present.

In some embodiments, determining the state of the game item based on the detection result of the operating object includes: determining, in response to detecting the operating object being present in the placement region from the previous frame of the second target image while not detecting the operating object from the second target image, the game item is in the preset stable state; or determining, in response to detecting the operating object being present in the placement region from the previous frame of the second target image while a distance between the operating object and the game item in the second target image is greater than a second preset distance threshold, the game item is in the preset stable state.

In some embodiments, determining the state of the game item based on the detection result of the operating object includes: determining, in response to detecting that the operating object for the game item is present, the game item is in the preset stable state.

In some embodiments, determining the state of the game item based on the video stream further includes: determining, in response to not detecting the operating object for the game item based on the video stream, the game item is not in the preset stable state.

In some embodiments, a prop operated in the prop operating state includes a game coin; and the game item includes a card.

According to a second aspect of an embodiment of the present disclosure, provided is an apparatus for controlling game states, including: an obtaining module, configured to obtain a video stream of a game region in response to that a game is in a preset prop operating state, where the game region includes a placement region for placing one or more game items; a detecting module, configured to determine whether a game item is present in the placement region by performing detection on the video stream; a state module, configured to determine a state of the game item based on the video stream in response to that the game item is present in the placement region; and a switching module, configured to switch the game to an item operating state in response to that the game item is in a preset stable state.

In some embodiments, the detecting module is specifically configured to: obtain a confidence of the game item in the placement region by performing game item detection for at least one image in the video stream; and in response to that the confidence of the game item in the placement region is greater than a preset confidence threshold, determine the game item is present in the placement region.

In some embodiments, the state module is specifically configured to: obtain a detection result obtained by performing game item detection for a plurality of successive images in the video stream, where the detection result includes a position of the game item in each of the plurality of successive images; in response to that the plurality of successive images include at least one first target image, determine the game item is in the preset stable state; where a first position corresponding to the game item in the first target image is within the placement region, and a distance between the first position with respect to each of second positions is smaller than a first preset distance threshold or a distance between the first position with respect to each of third positions is smaller than the first preset distance threshold, the second positions indicate respective positions corresponding to the game item in n previous frames of the first target image, the third positions indicate respective positions corresponding to the game item in n subsequent frames of the first target image, and n is a positive integer.

In some embodiments, the state module is specifically configured to: detect an operating object for the game item based on the video stream; and determine the state of the game item based on a detection result of the operating object.

In some embodiments, when used to detect the operating object for the game item based on the video stream, the state module is specifically configured to: detect a second target image in which a game item is present in the placement region from the video stream; and detect the operating object for the game item from a previous frame of the second target image.

In some embodiments, when used to determine the state of the game item based on the detection result of the operating object, the state module is specifically configured to: in response to detecting the operating object being present in the placement region from the previous frame of the second target image while not detecting the operating object from the second target image, determine the game item is in the preset stable state; or in response to detecting the operating object being present in the placement region from the previous frame of the second target image while a distance between the operating object and the game item in the second target image is greater than a second preset distance threshold, determine the game item is in the preset stable state.

In some embodiments, the state module is specifically configured to: in response to detecting that the operating object for the game item is present, determine the game item is in the preset stable state.

According to a third aspect of an embodiment of the present disclosure, provided is an electronic device, including a memory, a processor and computer instructions stored in the memory and run on the processor, where the computer instructions are executed by the processor to implement the method according to the first aspect.

According to a fourth aspect of an embodiment of the present disclosure, provided is computer readable storage medium storing computer programs, where the programs are executed by a processor to implement the method according to the first aspect.

As known from the above embodiments, when a game is in a preset prop operating state, a video stream of a game region is obtained and detection can be performed on the video stream to determine whether a game item is present in a placement region included in the game region, where the placement region is used for placing one or more game items. In response to that the game item is present in the placement region, a state of the game item based on the video stream is determined and finally the game is switched to an item operating state in response to that the game item is in a preset stable state. In the method of controlling game states, whether a game item is present in the game region and the state of the game item can be automatically detected based on the video stream of the game region, and the game can be automatically switched to the item operating state, which reduces labor costs, improves the switching efficiency of the game states, thus facilitating normal process of the smart game analysis.

It should be understood that the above general descriptions and subsequent detailed descriptions are merely illustrative and explanatory rather than limiting the present disclosure.

### BRIEF DESCRIPTION OF THE DRAWINGS

The accompanying drawings, which are incorporated in and constitute a part of the present description, illustrate embodiments consistent with the present disclosure and serve to explain the principles of the present disclosure together with the description.

FIG. 1 is a flowchart of a method of controlling game states according to an embodiment of the present disclosure.

FIG. 2 is a schematic diagram of a tabletop region according to an embodiment of the present disclosure.

FIG. 3 is a schematic diagram of a tabletop region according to another embodiment of the present disclosure.

FIG. 4 is a structural schematic diagram of an apparatus for controlling game states according to an embodiment of the present disclosure.

FIG. 5 is a structural schematic diagram of an electronic device according to an embodiment of the present disclosure.

### DETAILED DESCRIPTION OF THE EMBODIMENTS

Exemplary embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The term used in the present disclosure is for the purpose of describing a particular example only, and is not intended to be limiting of the present disclosure. The singular forms such as “a”, ‘said”, and “the” used in the present disclosure and the appended claims are also intended to include multiple, unless the context clearly indicates otherwise. It is also to be understood that the term “and/or” as used herein refers to any or all possible combinations that include one or more associated listed items.

It is to be understood that although different information may be described using the terms such as first, second, third, etc. in the present disclosure, these information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to”.

A complete game is usually divided into a plurality of different states. In the process of a game, the game is switched to a corresponding state based on a game progress. For example, a tabletop card game is usually divided into states such as a prop operating state, and an item operating state. Specifically, when the game is in the prop operating state, a game object participating in the game places a prop such as a game coin in a prop region, where types and the number of props, and a sub-region of a prop region and the like may represent participation degree of the game object; when each game object completes the operation of the props, a card dealer as an operating object participating in the game may deal cards.

At present, game states are switched by a relevant staff with either doing some specific actions or operating a designated button. For example, in a tabletop card game process, if each game object completes the operation of a prop, the game is switched from the prop operating state to the item operating state, the card dealer as the operating object participating in the game may do specific actions to be recognized by a detection device, so as to trigger the game to be switched from the prop operating state to the item operating state; alternatively, the card dealer as the operating object participating in the game may operate a physical or virtual button on a client, so as to trigger the game to be switched from the prop operating state to the item operating state. Apparently, this manner of controlling game states depends on manual operation, leading to labor wastes and low efficiency.

Based on this, according to a first aspect, at least one embodiment of the present disclosure provides a method of controlling game states. As shown in FIG. 1, the flow of the method includes steps S101-S103.

The method may be implemented by an electronic device such as a terminal device or a server. The terminal device may be an user equipment (UE), a mobile device, an user terminal, a terminal, a cellular phone, a cordless phone, a personal digital assistant (PDA), a hand-held device, a computing device, a vehicle-mounted device, and a wearable device and the like. The method may be implemented with a processor by invoking computer readable instructions stored in a memory. Alternatively, the method may be implemented by a server which may be a local server or a cloud server or the like.

At step S101, obtaining, in response to that a game is in a preset prop operating state, a video stream of a game region, where the game region includes a placement region for placing one or more game items.

The prop operating state indicates a state before an item operating state. When the game is in the prop operating state, a game object participating in the game may place a prop in one or more prop sub-regions of a prop region to represent that the game object participates in this round of game. The information such as the number of props may also be used to represent participation degree of the game object in this round of game. When the game object completes one or more operations performed on the prop, the prop operating state can be ended and the game can be switched to the item operating state. For example, during a tabletop card game, a tabletop region may be needed to carry out the game, a certain local region of the tabletop region may be defined as a prop region which may be divided into a plurality of prop sub-regions, and the prop sub-regions are marked with different participation degree respectively; props may be game coins which have different face values. Therefore, the face value, the number and the position (i.e. the sub-region) of the game coins placed in the prop region by the game object can represent different participation degree. The game object may place the game coins at his will.

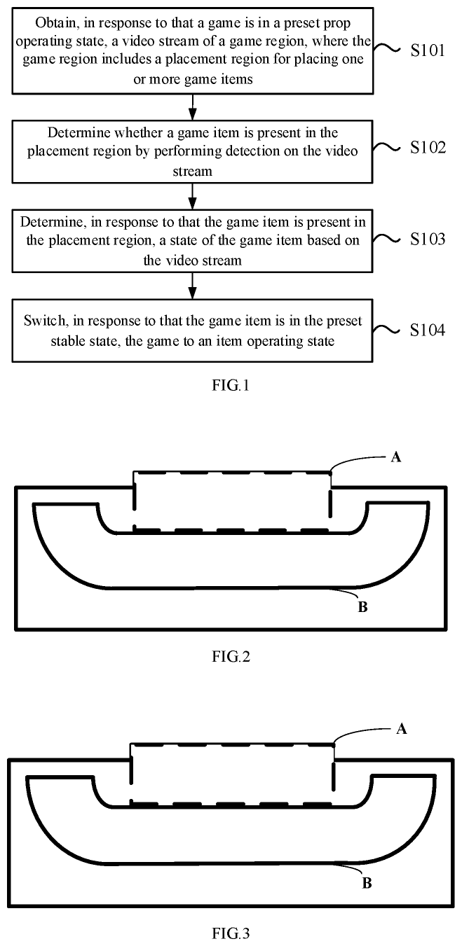

The game region indicates a region where players and other game participants (e.g. a game manager) carry out a game, including the prop operating region and the placement region for placing the game items as above. The placement region for placing the game items indicates a region in which an operating object places a game item, for example, a card dealing region in a tabletop card game. Still taking the above tabletop card game as an example, the placement region of placing the game items indicates another local region different from the prop region in the tabletop region. Referring to the tabletop region shown in FIG. 2, a region A indicates a placement region for placing a game item, and a region B indicates a prop region.

The video stream of the game region includes video streams captured synchronously from a plurality of viewing angles in the game region. The plurality of viewing angles include one or more side viewing angles and one or more top viewing angles. The side viewing angle includes one or more left side viewing angles and/or one or more right side viewing angles. In a possible implementation, the video stream of the game region may be obtained by a video acquisition device disposed in advance. For example, the video acquisition device may be installed above the game region used in the tabletop card game to obtain the video stream of the game region. It should be understood that the video stream of the game region may be obtained in many manners and thus will not be limited to the above example.

At step S102, determining whether a game item is present in the placement region by performing detection on the video stream.

The game item includes an article used for determining a game result in a game process. For example, a card used in a tabletop card game may be used as the game item of the embodiment. During a tabletop card game, a card dealer as the operating object is to deal the game items “cards” to the placement region in the game region.

When the video stream of the game region is obtained, in order to determine whether the game item is present in the placement region, performing the detection on the video stream of the game region may be implemented in many manners, which is not limited in the embodiment. In a possible implementation, an identification network for identifying the game item involved in video stream may be acquired based on pre-training a learnable machine learning model or a neural network model, so that the trained identification network may be used to perform the detection on the video stream when the game item in the game region is to be detected.

In some optional embodiments, determining whether the game item is present in the placement region by performing the detection on the video stream of the game region includes: obtaining a confidence of the game item in the placement region by performing game item detection for at least one image in the video stream; and in response to that the confidence of the game item in the placement region is greater than a preset confidence threshold, determining the game item is present in the placement region. Taking the tabletop card game as an example, a confidence of a card in the placement region of the game region (i.e. a probability that an identified object is a card) is firstly determined, and the confidence of the card is compared with a confidence threshold; if the confidence of the card is greater than the confidence threshold, it is determined that the identified object is the card, that is, the card is present in the placement region. The confidence represents trustability degree that a game item is present, which can be output by a trained neural network.

Whether a game item is present is determined by comparing the confidence of the game item with the confidence threshold. In this way, it can not only avoid detecting other articles as game items, but also avoid missing a game item. That is, the detection accuracy of the game item can be improved in two aspects. Further, the confidence threshold may be preset and may be adjusted empirically to achieve accurate detection of the game item.

At step S103, determining, in response to that the game item is present in the placement region, a state of the game item based on the video stream.

The number of game items present in the game region is not limited. Presence of one or more game items may be deemed as presence of the game item in the placement region and the determination of the state of the game item is triggered. It is noted that the method of controlling game states provided in the embodiment aims to accurately switch the game states. Theoretically, the game should be switched to the item operating state immediately after detecting that the game item appears in the game region. Therefore, the instant that the game item appears can be locked by improving the detection accuracy of the video stream so as to detect the state of the game item in time. Still taking the tabletop card game as an example, when a card appears in the game region, the state of the card is detected.

The state of the game item can be determined in multiple aspects such as position stability and a state of an operating object.

For the position stability, whether the position of the game item is stable may be determined. If the position of the game item is stable, it is suitable for the game to be switched to the item operating state, that is, the game item is in a preset stable state. If the position of the game item is unstable, it is not suitable for the game to be switched to the item operating state, that is, the game item is not in the preset stable state. Taking the tabletop card game as an example, when the position of a card in the placement region is stable, it is determined the card is in a stable state, and otherwise, when the position of the card in the placement region is not stable, it is determined the card is not in a stable state.

For the state of the operating object, the operating object for the game item may be detected based on the video stream. If the operating object for the game item is detected to be present (for example, in the game region), the game may be switched to the item operating state, that is, the game item is placed in a corresponding placement region by the operating object, and thus, it is determined the game item is in the preset stable state. If the operating object for the game item is not detected to be present (for example, in the game region), it is not suitable to switch the game to the item operating state, that is, the game item is not in the preset stable state.

Taking the tabletop card game as an example, when a hand of a card dealer is detected, it is determined that a card is in the preset stable state; when the hand of the card dealer is not detected, it is determined that the card is not in the preset stable state. Detecting the operating object indicates that the game item is operated by the operating object according to a game rule, for example, detecting the hand of the card dealer indicates that the card is dealt by the card dealer to a card dealing region. In this case, the state of the game item is in compliance with the game rule and the possibility that the game item is present due to misoperation or cheat is eliminated. Therefore, state of the game item is accurately determined and complies with the game rule.

The state of the game item can be determined based on the states determined for the above various aspects. For example, when a state determined based on any one aspect indicates the preset stable state, it is determined that the game item is in the preset stable state. For another example, when a state determined based on each aspect indicates the preset stable state, it is determined that the game item is in the preset stable state.

At step S104, switching, in response to that the game item is in the preset stable state, the game to an item operating state.

Switching the game to the item operating state when the game item is in the preset stable state can reduce mis-switchings when the game item is in an unstable state, further improving the accuracy of controlling the game states.

In the above embodiments of the present disclosure, the video stream of the game region can be obtained and detection can be performed on the video stream when the game is in the preset prop operating state, so as to determine whether the game item is present in the placement region included in the game region, where the placement region is used for placing one or more game items. The state of the game item can be determined based on the video stream in response to the game item is present in the placement region, and finally the game is switched to the item operating state in response to that the game item is in the preset stable state. In the method of controlling game states, whether a game item is present in the game region and the state of the game item may be automatically detected based on the video stream of the game region, and the game may be automatically switched to the item operating state, thereby reducing the labor costs, increasing the switching efficiency of the game states and facilitating normal process of the game analysis or game supervision.

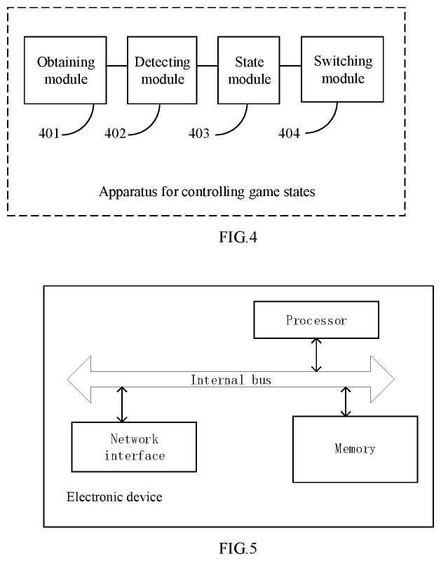

In some embodiments of the present disclosure, the placement region includes at least two placement sub-regions. The at least two placement sub-regions may be in correspondence with a plurality of prop sub-regions. That is, after a game object participating in a game places a prop in a prop sub-region and an operating object participating in the game places a game item in different placement sub-regions, a game result is acquired in combination with the prop sub-region for placing the prop and the game item placed in different placement sub-regions. Taking the tabletop card game as an example, the cards in different placement sub-regions may be used to determine a winning or losing result of players corresponding to the placement sub-regions, and further, a winning or losing result of the prop sub-regions corresponding to the placement sub-regions is determined. Referring to the tabletop region shown in FIG. 3, the region A indicates a placement region including a placement sub-region A1 and a placement sub-region A2, and the region B indicates a prop region including a sub-region B1 and a sub-region B2.

Based on the form of the above game region, the detection on the video stream may be performed in the following manner to determine whether a game item is present in the placement region: firstly, for each of the placement sub-regions of the placement region, whether the game item is present in the placement sub-region is determined by performing the detection on the placement sub-region based on the video stream; next, in response to that the game item is present in any one of the placement sub-regions, it is determined that the game item is present in the placement region.

The operating object may place a game item in each placement sub-region based on a game rule. Therefore, when the game item is present in any one placement sub-region, it is determined that the game item is present in the placement region. Taking the tabletop card game as an example, the placement region includes two placement sub-regions. The card dealer as an operating object deals cards to the two placement sub-regions alternately, that is, the card dealer deals one card to the first placement sub-region and one card to the second placement sub-region, and then one card to the first placement sub-region and one card to the second placement sub-region and so on until the number of the cards in the two placement sub-regions respectively reaches a number specified by the game rule. Therefore, when the first card appears in the first placement sub-region, it is determined that the card is present in the placement region.

In some embodiments of the present disclosure, for a common case that a placement region includes a plurality of placement sub-regions, whether a game item is present in each placement sub-region is determined by performing the detection on each placement sub-region, and when the game item is present in any one of the placement sub-regions, it is determined that the game item is present in the placement region. In this way, the detection accuracy and timeliness of the game item are increased and the switching accuracy of the game states is improved.

In some embodiments of the present disclosure, the position stability included in the state of the game item may be determined in the following manner: firstly, a detection result is obtained by performing game item detection for a plurality of successive images in the video stream, where the detection result includes a position of the game item in each of the plurality of successive images; in response to that the plurality of successive images include at least one first target image, it is determined that the game item is in the preset stable state, where a first position corresponding to the game item in the first target image is within the placement region, and a distance between the first position with respect to each of second positions is smaller than a first preset distance threshold or a distance between the first position with respect to each of third positions is smaller than the first preset distance threshold, the second positions indicate respective positions corresponding to the game item in n previous frames of the first target image, the third positions indicate respective positions corresponding to the game item in n subsequent frames of the first target image, and n is a positive integer.

The first preset distance threshold and the n may be preset. It is understood that the larger n means more accurate detection result with higher energy consumption and lower efficiency; the smaller n means more inaccurate detection result with lower energy consumption and higher efficiency. Therefore, the value of n may be determined by finding a balance point among several aspects such as accuracy, energy consumption and efficiency. The position stability of the game item in each image can be determined based on change of position of the game item in different images, that is, the position stability of the game item in the placement region during a time period corresponding to each image can be determined. When the game item is in a stable position in the placement region, it is determined that the game item is in the preset stable state, which greatly increases the accuracy of detecting the game item.

In some embodiments of the present disclosure, the state of the game item may be determined in the following manner: firstly detecting an operating object for the game item based on the video stream, and next, determining the state of the game item based on a detection result of the operating object.

The operating object is a person in charge of operating a game item in a game, who controls the process of the game as a manager or a controller of the game. A requisite precondition for a game item to appear in the game region is that an operator appears in the game region. Taking a tabletop card game as an example, a card dealer as an operator may take out a card from a card dealing machine and deal the card to the placement region of the game region.

In an example, when the operating object for the game item is detected based on the video stream, a second target image in which a game item is detected to be present in the placement region may be firstly detected from the video stream; then, the operating object for the game item is detected from a previous frame of the second target image.

The number of the previous frames may be preset to, for example, 5. When the operating object is detected from any of the previous frames, it is determined that the operating object is detected. An operation sequence in which the operating object operates the game item is as follows: taking out a game item from a storage region for storing game items, placing the game item in a placement region of a game region, and leaving the placement region. Therefore, detecting the operating object from the previous frame of the second target image is very targeted in time sequence, which will not only reduce the detection load and improve the detection efficiency, but also increase the reliability that the game item is in the preset stable state, thus improving the accuracy of switching the game states.

When detecting the operating object for the game item from the previous frame of the second target image, an operating object in the placement region may be detected from the previous frame of the second target image; and, in response to detecting the operating object being present in the placement region from the previous frame of the second target image, it is determined that the operating object for the game item is present. When an operating object in the placement region is detected from any one of the previous frames, it is determined that the operating object being present in the placement region is detected from the previous frames. Detecting the operating object based on the placement region is very targeted in position, which will not only reduce the detection load and improve the detection efficiency but also increase the reliability that the game item is in the preset stable state, thus improving the accuracy of switching the game states.

In the above example, when an operating object is detected based on the video stream, an identification network for identifying the operating object involved in video stream may be acquired based on pre-training a learnable machine learning model or a neural network model, so that the trained identification network may be used to perform the detection on the video stream when the operating object is to be detected. When images (for example, previous frames of the first target image) in the video stream are to be detected, detection may be performed for each of the images with the trained identification network.

Furthermore, when identifying the operating object, a hand of the operating object may be identified. Based on the identification of the hand, a direction of the hand may be further identified. When the direction of the hand indicates an operation direction of the operating object, it is determined that the operating object appears. The operation direction of the operating object may be directly preset according to a position relationship of the operating object and an operating region, or autonomously learned by a model during a training process.

Based on above various manners of detecting the operating object, the state of the game item may be determined based on the detection result of the operating object in the following manner: in response to detecting the operating object being present in the placement region from the previous frame of the second target image while not detecting the operating object from the second target image, it is determined that the game item is in the preset stable state; or in response to detecting the operating object being present in the placement region from the previous frame of the second target image while a distance between the operating object and the game item in the second target image is greater than a second preset distance threshold, it is determined that the game item is in the preset stable state.

The operating object being present in the placement region is detected from the previous frame of the second target image, and the operating object is not detected from the second target image, or a distance between the operating object and the game item in the second target image is greater than the second preset distance threshold, which indicates that the operating object leaves after placing the game item in the placement region. In this way, it is indicated that the game item is in a stable state, which complies with the game rule and an operation habit of the operating object. Therefore, the determined result will be more accurate.

In this embodiment, whether an operating object is present in the placement region is determined based on the video stream, and it is determined that the game item is in the preset stable state in response to detecting that the operating object is present in the placement region. Based on detecting that the game item is present in the placement region, the detection for the operating object in the placement region is further performed. In this way, it is determined that the game item is placed in the placement region by the operating object. Thus, the reliability of determining the stability of the game item is ensured, the accuracy of the game switching is further improved, and some cheat actions in a game process are avoided.

According to a second aspect of an embodiment of the present disclosure, provided is an apparatus for controlling game states. As shown in FIG. 4, the apparatus includes the following modules: an obtaining module 401 is configured to obtain a video stream of a game region in response to that a game is in a preset prop operating state, where the game region includes a placement region for placing one or more game items. A detecting module 402 is configured to determine whether a game item is present in the placement region by performing detection on the video stream. A state module 403 is configured to determine a state of the game item based on the video stream in response to that the game item is present in the placement region. A switching module 404 is configured to switch the game to an item operating state in response to that the game item is in a preset stable state.

In some embodiments, the detecting module is specifically configured to: obtain a confidence of the game item in the placement region by performing game item detection for at least one image in the video stream; and in response to that the confidence of the game item in the placement region is greater than a preset confidence threshold, determine the game item is present in the placement region.

In some embodiments, the state module is specifically configured to: obtain a detection result obtained by performing game item detection for a plurality of successive images in the video stream, where the detection result includes a position of the game item in each of the plurality of successive images; in response to that the plurality of successive images include at least one first target image, determine the game item is in the preset stable state; where a first position corresponding to the game item in the first target image is within the placement region, and a distance between the first position with respect to each of second positions is smaller than a first preset distance threshold or a distance between the first position with respect to each of third positions is smaller than the first preset distance threshold, the second positions indicate respective positions corresponding to the game item in n previous frames of the first target image, the third positions indicate respective positions corresponding to the game item in n subsequent frames of the first target image, and n is a positive integer.

In some embodiments, the state module is specifically configured to: detect an operating object for the game item based on the video stream; and determine the state of the game item based on a detection result of the operating object.

In some embodiments, when used to detect the operating object for the game item based on the video stream, the state module is specifically configured to: detect a second target image in which a game item is present in the placement region from the video stream; and detect the operating object for the game item from a previous frame of the second target image.

In some embodiments, when used to determine the state of the game item based on the detection result of the operating object, the state module is specifically configured to: in response to detecting the operating object in the placement region from the previous frame of the second target image while not detecting the operating object being present from the second target image, determine the game item is in the preset stable state; or in response to detecting the operating object being present in the placement region from the previous frame of the second target image while a distance between the operating object and the game item in the second target image is greater than a second preset distance threshold, determine the game item is in the preset stable state.

In some embodiments, the state module is specifically configured to: in response to detecting that the operating object for the game item is present, determine the game item is in the preset stable state.

For the apparatus in the above embodiment, the specific manner of executing various modules is already described in details in the method embodiments according to the first aspect and thus will not be repeated herein.

According to a third aspect, at least one embodiment of the present disclosure provides an electronic device. As shown in FIG. 5, the electronic device includes a memory, a processor and computer instructions stored in the memory and run on the processor. The computer instructions are executed by the processor to implement the method of controlling game states according to the first aspect.

According to a fourth aspect, at least one embodiment of the present disclosure provides a computer readable storage medium storing computer programs thereon. The programs are executed by a processor to implement the method according to the first aspect.

In the present disclosure, the terms “first” and “second” are used only for the purpose of descriptions and shall not be understood as indicating or implying relative importance. The term “plurality” refers to two or more unless otherwise defined.

Other implementations of the present disclosure will be apparent to those skilled in the art from consideration of the specification and practice of the present disclosure herein. The present disclosure is intended to cover any variations, uses, or adaptive changes of the present disclosure that follow the general principles thereof and include common knowledge or conventional technical means in the related art that are not disclosed in the present disclosure. The specification and embodiments are considered as exemplary only, with a true scope and spirit of the present disclosure being indicated by the following claims.

1. A method of controlling game states, comprising:
obtaining, in response to that a game is in a preset prop operating state, a video stream of a game region, wherein the game region comprises a placement region for placing one or more game items;
determining whether a game item is present in the placement region by performing detection on the video stream;
determining, in response to that the game item is present in the placement region, a state of the game item based on the video stream; and
switching, in response to that the game item is in a preset stable state, the game to an item operating state.

2. The method according to claim 1, wherein determining whether the game item is present in the placement region by performing the detection on the video stream comprises:
obtaining a confidence of the game item in the placement region by performing game item detection for at least one image in the video stream; and
determining, in response to that the confidence of the game item in the placement region is greater than a preset confidence threshold, the game item is present in the placement region.

3. The method according to claim 1, wherein determining the state of the game item based on the video stream comprises:
obtaining a detection result obtained by performing game item detection for a plurality of successive images in the video stream, wherein the detection result comprises a position of the game item in each of the plurality of successive images;
determining, in response to that the plurality of successive images comprise at least one first target image, the game item is in the preset stable state;
wherein a first position corresponding to the game item in the first target image is within the placement region, and a distance between the first position with respect to each of second positions is smaller than a first preset distance threshold or a distance between the first position with respect to each of third positions is smaller than the first preset distance threshold,
the second positions indicate respective positions corresponding to the game item in n previous frames of the first target image,
the third positions indicate respective positions corresponding to the game item in n subsequent frames of the first target image, and
n is a positive integer.

4. The method according to claim 1, wherein the placement region comprises at least two placement sub-regions, determining whether the game item is present in the placement region by performing the detection on the video stream comprises:
determining, for each of the placement sub-regions of the placement region, whether the game item is present in the placement sub-region by performing the detection on the placement sub-region based on the video stream; and
determining, in response to that the game item is present in any one of the placement sub-regions, the game item is present in the placement region.

5. The method according to claim 1, wherein determining the state of the game item based on the video stream comprises:
detecting an operating object for the game item based on the video stream; and
determining the state of the game item based on a detection result of the operating object.

6. The method according to claim 5, wherein detecting the operating object for the game item based on the video stream comprises:
detecting a second target image in which a game item is present in the placement region from the video stream; and
detecting the operating object for the game item from a previous frame of the second target image.

7. The method according to claim 6, wherein detecting the operating object for the game item from the previous frame of the second target image comprises:
detecting an operating object in the placement region from the previous frame of the second target image; and
determining, in response to detecting the operating object being present in the placement region from the previous frame of the second target image, that the operating object for the game item is present.

8. The method according to claim 6, wherein determining the state of the game item based on the detection result of the operating object comprises:
determining, in response to detecting the operating object being present in the placement region from the previous frame of the second target image while not detecting the operating object from the second target image, the game item is in the preset stable state; or
determining, in response to detecting the operating object being present in the placement region from the previous frame of the second target image while a distance between the operating object and the game item in the second target image is greater than a second preset distance threshold, the game item is in the preset stable state.

9. The method according to claim 5, wherein determining the state of the game item based on the detection result of the operating object comprises:
determining, in response to detecting that the operating object for the game item is present, the game item is in the preset stable state.

10. The method according to claim 5, wherein determining the state of the game item based on the video stream further comprises:
determining, in response to not detecting the operating object for the game item based on the video stream, the game item is not in the preset stable state.

11. The method according to claim 1, wherein
a prop operated in the prop operating state comprises a game coin; and
the game item comprises a card.

12. An electronic device comprising:
at least one processor; and
one or more memories coupled to the at least one processor and storing programming instructions for execution by the at least one processor to perform operations for controlling game states, the operations comprising:
obtaining, in response to that a game is in a preset prop operating state, a video stream of a game region, wherein the game region comprises a placement region for placing one or more game items;
determining whether a game item is present in the placement region by performing detection on the video stream;
determining, in response to that the game item is present in the placement region, a state of the game item based on the video stream; and
switching, in response to that the game item is in a preset stable state, the game to an item operating state.

13. The electronic device according to claim 12, wherein determining whether the game item is present in the placement region by performing the detection on the video stream comprises:
obtaining a confidence of the game item in the placement region by performing game item detection for at least one image in the video stream; and
determining, in response to that the confidence of the game item in the placement region is greater than a preset confidence threshold, the game item is present in the placement region.

14. The electronic device according to claim 12, wherein determining the state of the game item based on the video stream comprises:
obtaining a detection result obtained by performing game item detection for a plurality of successive images in the video stream, wherein the detection result comprises a position of the game item in each of the plurality of successive images;
determining, in response to that the plurality of successive images comprise at least one first target image, the game item is in the preset stable state;
wherein a first position corresponding to the game item in the first target image is within the placement region, and a distance between the first position with respect to each of second positions is smaller than a first preset distance threshold or a distance between the first position with respect to each of third positions is smaller than the first preset distance threshold,
the second positions indicate respective positions corresponding to the game item in n previous frames of the first target image,
the third positions indicate respective positions corresponding to the game item in n subsequent frames of the first target image, and
n is a positive integer.

15. The electronic device according to claim 12, wherein the placement region comprises at least two placement sub-regions, determining whether the game item is present in the placement region by performing the detection on the video stream comprises:
determining, for each of the placement sub-regions of the placement region, whether the game item is present in the placement sub-region by performing the detection on the placement sub-region based on the video stream; and
determining, in response to that the game item is present in any one of the placement sub-regions, the game item is present in the placement region.

16. The electronic device according to claim 12, wherein determining the state of the game item based on the video stream comprises:
detecting an operating object for the game item based on the video stream; and
determining the state of the game item based on a detection result of the operating object.

17. The electronic device according to claim 16, wherein detecting the operating object for the game item based on the video stream comprises:
detecting a second target image in which a game item is present in the placement region from the video stream; and
detecting the operating object for the game item from a previous frame of the second target image.

18. The electronic device according to claim 17, wherein detecting the operating object for the game item from the previous frame of the second target image comprises:
detecting an operating object in the placement region from the previous frame of the second target image; and
determining, in response to detecting the operating object being present in the placement region from the previous frame of the second target image, that the operating object for the game item is present.

19. The electronic device according to claim 17, wherein determining the state of the game item based on the detection result of the operating object comprises:
determining, in response to detecting the operating object being present in the placement region from the previous frame of the second target image while not detecting the operating object from the second target image, the game item is in the preset stable state; or
determining, in response to detecting the operating object being present in the placement region from the previous frame of the second target image while a distance between the operating object and the game item in the second target image is greater than a second preset distance threshold, the game item is in the preset stable state.

20. A non-transitory computer readable storage medium coupled to the at least one processor and storing programming instructions for execution by the at least one processor, wherein the programming instructions instruct the at least one processor to perform operations for controlling game states, the operations comprising:
obtaining, in response to that a game is in a preset prop operating state, a video stream of a game region, wherein the game region comprises a placement region for placing one or more game items;
determining whether a game item is present in the placement region by performing detection on the video stream;
determining, in response to that the game item is present in the placement region, a state of the game item based on the video stream; and
switching, in response to that the game item is in a preset stable state, the game to an item operating state.
